(19) United States
(12) Patent Application Publication
(10) Pub. No.: US 2024/0420257 A1
(43) Pub. Date: Dec. 19, 2024

(54) SERVING ROBOT INTERLOCKING KITCHEN CONTROL SYSTEM CAPABLE OF PROCESSING CALLING BELL SIGNAL

(71) Applicant: RGT Inc., Daejeon (KR)

(72) Inventor: Ho Jeong JEONG, Daejeon (KR)

(73) Assignee: RGT Inc., Daejeon (KR)

(21) Appl. No.: 18/260,027

(22) PCT Filed: Jun. 26, 2023
(86) PCT No.: PCT/KR2023/008864

§ 371 Date: Jun. 29, 2023

(30) Foreign Application Priority Data
Aug. 31, 2022 (KR) 10-2022-0109880

(51) Int. Cl. G06Q 50/12

(52) U.S. Cl. CPC G06Q 50/12

(57) ABSTRACT

Disclosed is a service robot interlocking kitchen control system capable of processing a calling bell signal in that it checks and controls information about a serving robot capable of processing a calling signal generated from a calling bell as well as information of a hall (inside a store) in a kitchen, thereby ensuring smooth service mobility.

### TECHNICAL FIELD

The present invention relates a service robot interlocking kitchen control system capable of processing a calling bell signal, more specifically, to a service robot interlocking kitchen control system capable of processing a calling bell signal in that it checks information on the real-time state of a serving robot that drives through a hall (inside a store) in a kitchen, various service activities of the serving robot for the hall (inside the store) are facilitated according to the situation in the kitchen by using a calling function that calls the serving robot, and it enables the serving robot to process the calling signal of the calling bell installed on the customer table, so that the linkage of the calling signals of the calling bell among the kitchen, the serving robot, and the hall (inside the store) can be managed and controlled, thereby maximizing service flexibility in the kitchen and the hall (inside the store) and utilization and effectiveness of the serving robot.

### BACKGROUND ART

In the service industry that provides services such as restaurants, recently, the problem of service response is emerged, and the introduction of a 52-hour workweek and the increase in the minimum wage are in progress, increasing the burden of labor costs. Accordingly, the unmanned service market that does not employ employees has been rapidly expanded.

In particular, a KIOSK, which is an unmanned information guide system for providing unmanned orders and payments, is actively used by the service companies.

However, in a case of the service that provides foods or drinks completed through a cooking or a processing, the development of the unmanned technology is insufficient.

Due to the insufficiency of such technology development, currently, in Korea, the demand for the serving robots is being met by importing and then, selling or leasing the serving robots. However, since these imported serving robots are rather expensive, one serving robot is a burden on restaurant companies in terms of economic efficiency and productivity.

Therefore, at a time when companies are considering new types of restaurants such as futuristic and unmanned restaurants, there is an urgent need for domestically developed products that are inexpensive and have excellent functions.

In addition, since the current service robot is a system in which a manager inputs a unique number of a table to serve, the usability of the service robot is not excellent.

That is, although it is a service robot composed of expensive equipment, by actively utilizing it, a driving management system related to service provision of the service robot is insufficient to provide overall service in the room.

In addition, in order to maximize the usability of the serving robot, the serving robot that can be linked with a calling bell system that can easily receive various services in response to a calling signal generated by a customer's physical manipulation, and its control system are needed.

Accordingly, the present invention is intended to provide a kitchen control system linked to a serving robot in that the usability of the serving robot can be maximized by checking a real-time state of the serving robot as well as order information in the kitchen and easily controlling the provision of various services of the serving robot.

In other words, it is intended to provide the kitchen control system linked to the serving robot capable of processing the calling bell signal in that the serving robot can communicate smoothly with the serving robot in the kitchen and the hall (inside the store) and respond to the customer's calling signal using the calling bell, so that the serving robot can smoothly connect the kitchen and the hall (inside the store).

Accordingly, as a prior art for a service robot interlocking kitchen control system capable of processing a calling bell signal, “a robot control system, a robot control method, and a wireless call device” of Korean Patent Laid-Open Publication No. 10-2021-0119887 (hereinafter referred to as “Patent Literature 1”) is disclosed.

Patent Literature 1 relates to a system and a method for allowing a serving robot operated in a store to easily change the stop position or the autonomous traveling path thereof and allowing a user or a store employee to easily call the serving robot and the robot control system installed in a robot so as to control the robot, the robot control system comprising: a control module for controlling the robot to move along a preconfigured autonomous traveling path in an autonomous traveling mode; a mode switching module for switching the robot from the autonomous traveling mode to a movement path reconfiguration mode when predetermined switching conditions are satisfied while the robot is in the autonomous traveling mode; and a configuration module for, when the robot is moved by an external force in the movement path reconfiguration mode, tracking a movement path while the robot is moved by the external force and reconfiguring the autonomous traveling path on the basis of the tracked movement path.

As another prior art, “a robot system for restaurant serving” of Korean Patent Registration No. 10-2242380 (hereinafter referred to as “Patent Literature 2”) is disclosed.

In Patent Literature 2 relates to a robot system for restaurant serving includes a plurality of tables equipped with a furnace for raising a fire plate and a temperature controller that senses the temperature of the fire plate at a certain distance; an ordering robot in that, when a customer of visiting a restaurant sits at the table and presses the order robot call button of a pager provided on the table, it is transported through a main server to the table where the pager was pressed, and the customer's menu order is performed through a kiosk or through a voice module; a menu robot for loading food on a tray in the kitchen where the menu ordered by the customer is prepared and transporting the food to the customer's table; a side dish robot for conveying various side dishes for refilling on the tray to the table where the pager is pressed according to a control signal from the main server of receiving the calling signal of the pager, when the customer presses the side dish robot call button of the pager provided on the table; a beverage robot that receives the calling signal of the pager and carries various beverages on the tray to the table where the pager is pressed according to a control signal from the main serve, when the customer presses the beverage robot call button of the pager provided on the table; a meal assistance robot that drives to the table where the pager is pressed according to a control signal of the main server of receiving the calling signal of the pager and then, assists the customer with meals while putting, baking, flipping, and cutting the cooking object on the grill by sensing the surface temperature of the fire plate placed on the table's furnace, when the customer presses a meal assistance robot call button of the pager provided on the table; a follower robot that follows the employee providing the service corresponding to the customer's request and assists in arranging the table or loading and providing various items on multi-tiered trays; and a main server that detects the position and the operating state of all robots operating in the restaurant and signal generators owned by employees, performs data communication with the pagers, the temperature controllers and the POS terminals installed on each table through wired and wireless communication networks. Accordingly, it is possible to provide meals to the customers while cooking various menus, thereby improving service to the customers in restaurants.

As described above, Patent Literatures 1 and 2 are technologies related to the control system for controlling the serving robot that serves the customers in the field, and has the same technical field as the present invention, however the technical characteristics of the invention are different from each other.

That is, Patent Literatures 1 is a technology that can easily and conveniently change the self-driving route or stopping position of the serving robot in the store, and can easily call the serving robot when the serving robot for serving food is needed.

Patent Literature 2 is a technology for a control system that manages and controls the assistant robot, such as taking orders from various menus at the restaurant, serving side dishes, drinks, and alcoholic beverages, cutting meat, or following the serving staff member to set or organize the tables.

Accordingly, Patent Literature 1 and Patent Literature 2 are different from the present invention in terms of the problem to be solved by the invention, the means for solving the problem, and the effect exerted by solving the problem.

Accordingly, the present invention is different from the technology for the conventional control system of the service robots including the Patent Literature 1 and Patent Literature 2. Also, the present invention seeks to achieve the technical features based on the problem to be solved by the invention (object of the invention), a solution means (element) for solving it, and the effect exerted by solving the same.

### PATENT LITERATURE

Patent Literature 1: Korean Patent Laid-Open Publication No. 10-2021-0119887 (Oct. 6, 2021)
Patent Literature 2: Korean Patent Registration No. 10-2242380 (Apr. 20, 2021)

### DISCLOSURE

### Technical Problem

In this respect, the present invention is made to solve the above-described problem in the related art, and an object thereof is to provide a service robot interlocking kitchen control system capable of processing a calling bell signal in that it checks a real-time state of a serving robot as well as the order information and requests input from the customer in the kitchen, controls the serving robot according to order information and requesting item input from the customer as well as the situation in the kitchen, enables the service mobility of the restaurant to proceed smoothly, the serving robot responds to a calling signal generated from a calling bell located in the hall (inside the store), and in response thereto, smooth communication among the kitchen, the hall (inside the store), and the customers is achieved.

That is, an object thereof is to provide a service robot interlocking kitchen control system capable of processing a calling bell signal in that can maximize the utilization of the serving robot and can perfectly control the situation of the hall, by enabling the management and the control of information on the serving robot that can process the calling signal of the calling bell and the hall (inside the store) in the kitchen.

### Technical Solution

According to one aspect of the present invention so as to accomplish these objects, there is provided to a service robot interlocking kitchen control system capable of processing a calling bell signal according to the present invention including:
an order table means where a customer can sit down and that requests an order;
a serving robot calling means located and formed on one side of the order table means and capable of calling a serving robot means with the order table means, where the customer is located, through a physically manipulation of the customer;
a calling signal information bridge means that receives calling signal information including information of the order table means through the serving robot calling means and transmits the received calling signal information to the serving robot means;
a kitchen serving robot interlocking main control server means linked to a kitchen serving robot that receives, stores, and manages information of the order table means calling in real time through the serving robot calling means, order information and requesting item input by the customer in real time using the serving robot means, information of the serving robot means, and Real-time state information transmitted in real time from the serving robot means, receives callable information about the serving robot means transmitted through a serving robot control server means, and allows the serving robot means to be called into the kitchen, based on the calling information;
the serving robot control server means that receives order information and requesting item and information on the serving robot means in position from the kitchen serving robot interlocking main control server means, and materializes information to call the serving robot means through the kitchen serving robot interlocking main control server means, based on the received order information and requesting item, and the information of the serving robot means in possession;
the serving robot means that provides various services by driving the kitchen and hall (inside the store) through the call of the kitchen serving robot interlocking main control server means and the call by the serving robot calling means, based on the information transmitted from the serving robot control server means to the kitchen serving robot interlocking main control server means and the calling signal information transmitted from the calling signal information bridge means;
a hall-serving robot information output means that is positioned and installed in the kitchen, outputs the order information and requesting item of the customer input from the order table means and the serving robot means, the information of the order table means called through the serving robot calling means, and the information processed by the serving robot control server means, and allows the serving robot means to be called into the kitchen, through the kitchen serving robot interlocking main control server means; and
a kitchen control system control means that manages information transfer between the order table means, the kitchen serving robot interlocking main control server means, the serving robot control server means, the serving robot means, the hall-serving robot information output means, the serving robot calling means, and the calling signal information bridge means,
wherein, in the kitchen, the order information and requesting item input through the order table means and the serving robot means and the real-time information of the serving robot means are checked, and the serving robot means is called, thereby managing and controlling the serving robot means in the kitchen so as to provide optimal service by the serving robot means; and
the serving robot means can be called and the customer can easily receive various services through the serving robot means with the use of the serving robot calling means by the customer in the order table means.

At this time, the serving robot means includes:
a serving robot mechanic body part that drives through the kitchen and the hall (inside the store), based on the calling signal transmitted through the kitchen serving robot interlocking main control server means and the calling signal information bridge means and that is a mechanical medium for connecting the kitchen and the customers; and
a serving robot control unit that controls the serving robot mechanic body to drive through the kitchen and the hall (inside the store), based on the calling signal transmitted through the kitchen serving robot interlocking main control server means and the calling signal information bridge means,
wherein the serving robot control unit includes:
a serving robot calling signal receiving module for receiving the calling signal transmitted from the kitchen serving robot interlocking main control server means;
a calling signal information receiving module for receiving the calling signal information by the customers transmitted from the calling signal information bridge means;
a serving robot calling and driving module for driving to the kitchen, which is a calling place, and a corresponding order table means located in the hall (inside the store) according to the calling signal received by the serving robot calling signal receiving module and the calling signal information receiving module;
a serving robot service providing module for completing the requesting item requested from the kitchen serving robot interlocking main control server means and the customers by driving to the kitchen and the order table means located in the hall (inside the store) by means of the serving robot calling and driving module; and
a serving robot real-time state transmission module that transmits its real-time state to the kitchen serving robot interlocking main control server means,
wherein the real-time state of the serving robot mechanic body part is transmitted to the kitchen serving robot interlocking main control server means and, based on this, the calling signal transmitted from the kitchen serving robot interlocking main control server means and various requesting items can be completed, and
wherein the customer's calling signal using the serving robot call means is received through the calling signal information bridge means, so that it is moved to the order table means where the calling signal is generated, thereby carrying out the customer's requesting item.

In the meantime, it should be understood that the terminology or the words used in claims should not be interpreted in normally or lexically sense. It should be interpreted as meaning and concept consistent with the technical idea of the present invention, based on the principle that the inventor can properly define the concept of the term in order to describe its invention in the best way.

Therefore, the embodiments described in the present specification and the configurations shown in the drawings are only the most preferred embodiments of the present invention, and not all the technical ideas of the present invention are described. Therefore, it is to be understood that various equivalents and modifications are possible.

### Advantageous Effects

As described above with respect to the above configuration and operation, the effects of the present invention are as follows.
1. It can thoroughly control and manage the serving robot that runs in the kitchen and the hall (inside the store).

That is, it is possible to provide various services according to the controlling of the serving robot by responding to situations of the kitchen and the hall (inside the store) in the kitchen.
2. it can maximize the utilization of the serving robot through thorough control and management of the serving robot.
3. it can systematically manage the situation in the kitchen and the hall (inside the store).

That is, the fluidity of the service of the restaurant and the hall (inside the store) is made smooth.
4. Depending on the situation in the kitchen and the hall (inside the store), the serving robot can respond immediately to improve the quality of the service.
5. it can promote smooth communication between the kitchen and the serving robot.

In other words, by controlling the serving robot, which is a medium that connects the kitchen and the customer, it is possible to perfectly fulfill the needs of the customer as well as the kitchen.
6. Also, the customers can call the serving robot using a calling bell.

That is, when the customer located in the hall (inside the store) generates the calling signal using the calling bell through a physical manipulation thereof, the serving robot receives the calling signal generated by the customer, responds to the call signaling, and moves to the customer where the calling bell signal is generated, so that the customer can easily receive various services.

That is, as described above, the present invention a very effective invention that it checks the order information and requesting item input from the customers in the kitchen using an output device (display), checks the real-time state of the serving robot that drives through the kitchen and the hall (inside the store), provides the service to the customer by calling the necessary serving robot, easily receives various services by calling the serving robot using the customer's calling bell, and improves the fluidity of the services through the linkage between the kitchen, the serving robot and the calling bell.

That is, it is a very effective invention that maximizes the usability and the effectiveness of the serving robot by allowing the serving robot to be controlled and managed in the kitchen and allowing the serving robot to receive the signal of the calling bell and respond to it.

### BRIEF DESCRIPTION OF DRAWINGS

The above and other objects, features and advantages of the present invention will be more apparent from the following detailed description taken in conjunction with the accompanying drawings, in which:

FIG. 1 illustrates a conceptual diagram of a service robot interlocking kitchen control system capable of processing a calling bell signal according to the present invention;

FIG. 2 illustrates a schematic block diagram of a service robot interlocking kitchen control system capable of processing a calling bell signal according to the present invention;

FIG. 3 illustrates an example view of a list requesting message of a serving robot means of a service robot interlocking kitchen control system capable of processing a calling bell signal according to the present invention;

FIG. 4 illustrates an example view of a calling message of a serving robot means of a service robot interlocking kitchen control system capable of processing a calling bell signal according to the present invention;

FIG. 5 illustrates an example view of a serving requesting message of a serving robot means of a service robot interlocking kitchen control system capable of processing a calling bell signal according to the present invention;

FIG. 6 illustrates an example view of a serving and calling completion message of a serving robot means of a service robot interlocking kitchen control system capable of processing a calling bell signal according to the present invention;

FIG. 7 illustrates a schematic block diagram of a process for receiving order information and calling a serving robot means of a serving robot interlocking kitchen control system capable of processing a calling bell signal according to the present invention;

FIG. 8 illustrates a schematic block diagram of a process for serving of a serving robot means of a serving robot interlocking kitchen control system capable of processing a calling bell signal according to the present invention;

FIG. 9 illustrates a schematic block diagram of a process for transmitting real-time state information of a serving robot means of a serving robot interlocking kitchen control system capable of processing a calling bell signal according to the present invention;

FIG. 10 illustrates a conceptual diagram of a process for transmitting real-time state information of a serving robot means of a serving robot interlocking kitchen control system capable of processing a calling bell signal according to the present invention;

FIG. 11 illustrates a conceptual diagram of a process for a calling transmitted to a serving robot means of a serving robot interlocking kitchen control system capable of processing a calling bell signal according to the present invention;

FIG. 12 illustrates a schematic first block diagram of a process for processing a calling bell signal of a serving robot interlocking kitchen control system capable of processing a calling bell signal according to the present invention;

FIG. 13 illustrates a schematic second block diagram of a process for processing a calling bell signal of a serving robot interlocking kitchen control system capable of processing a calling bell signal according to the present invention; and

FIG. 14 illustrates a schematic third block diagram of a process for processing a calling bell signal of a serving robot interlocking kitchen control system capable of processing a calling bell signal according to the present invention.

### REFERENCE SIGNS LIST

1: Service robot interlocking kitchen control system capable of processing calling bell signal
100: Order table means
110: Customer order information input unit
120: Service physical receiving unit
200: Kitchen serving robot interlocking main control server means
210: Main control customer order information receiving unit
211: First table information receiving module
212: First service information receiving module
220: Main control customer order information storage unit
230: Main control serving robot call function unit
240: Main control serving robot information management unit
250: Serving robot real-time state information transmission unit
300: Serving robot control server means
310: Main control server transmission information receiving unit
311: Second table information receiving module
312: Second service information receiving module
320: Main control server transmission information storage unit
330: Main control serving robot information receiving unit
340: Callable serving robot means inquiry unit
350: Serving robot means state inquiry unit
351: Callable serving robot means list module
352: Callable serving robot means state information acquisition module
360: Serving robot means calling requesting unit
400: Serving robot means
410: Serving robot mechanic body part
420: Serving robot control unit
421: Serving robot calling signal receiving module
422: Calling signal information receiving module
422-1: Calling bell calling signal receiving element
422-2: Call information message queue confirmation element
422-3: Serving robot state machine change value update element
422-4: Serving robot state information update element
423: Serving robot driving module
423-1: General calling driving element
423-2: Calling bell calling driving element
424: Serving robot service providing module
425: Serving robot real-time state transmission module
430: Serving robot colleague consciousness generating unit
500: Hall-serving robot information output means
600: Kitchen control system control means
A: Serving robot calling means
A1: Service request serving robot calling button unit
A2: Menu designation serving robot calling button unit
A3: Serving robot calling cancellation button unit
B: Calling signal information bridge means
B1: Serving robot calling signal receiving unit
B2: serving robot calling signal transmission unit

### BEST MODE

### Mode for Invention

Hereinafter, functions, configurations, and operations effect a kitchen control system (1) interlocked with a serving robot capable of processing a calling bell signal according to the present invention will be described in detail with reference to the accompanying drawings.

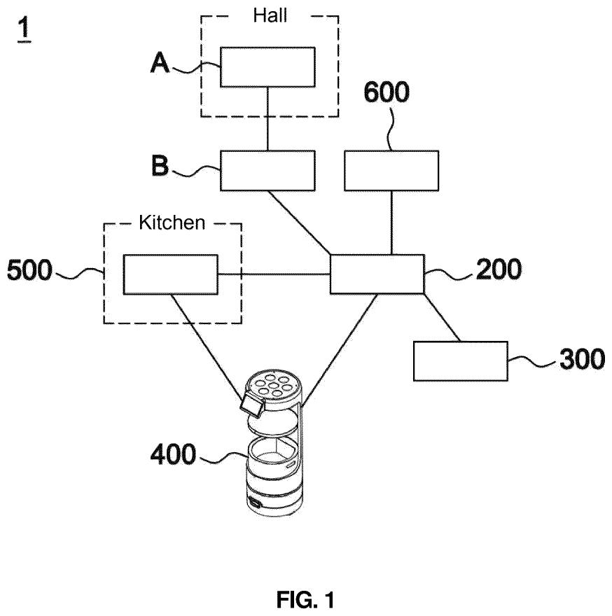

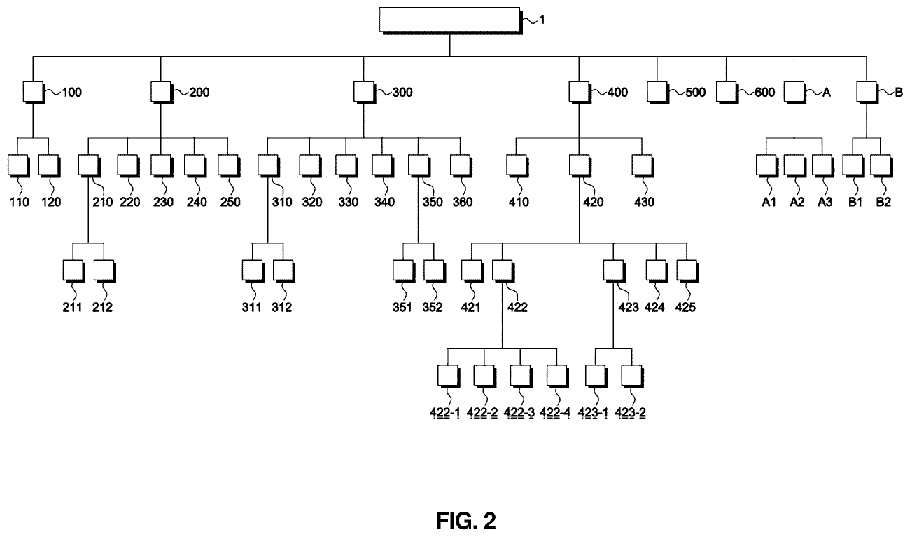

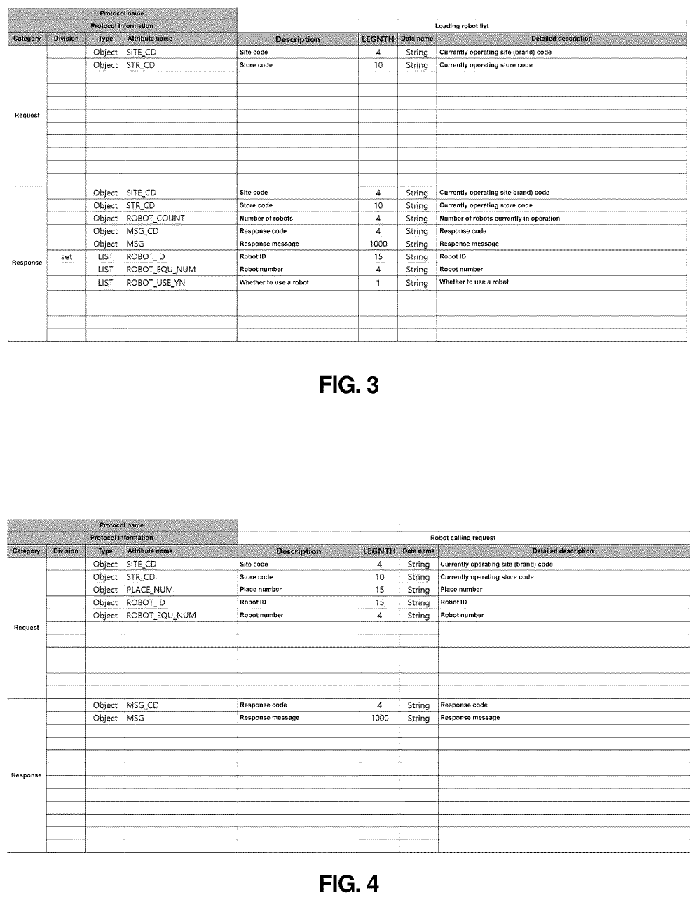

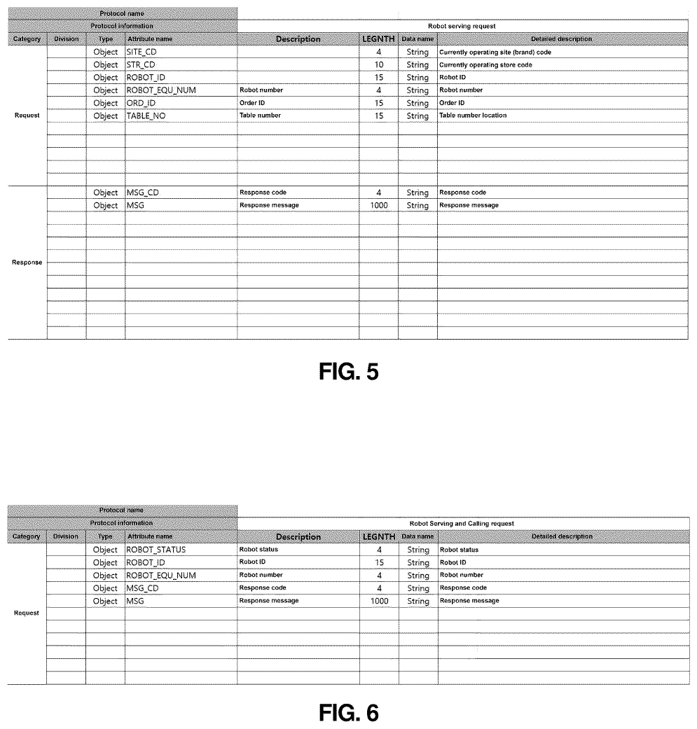

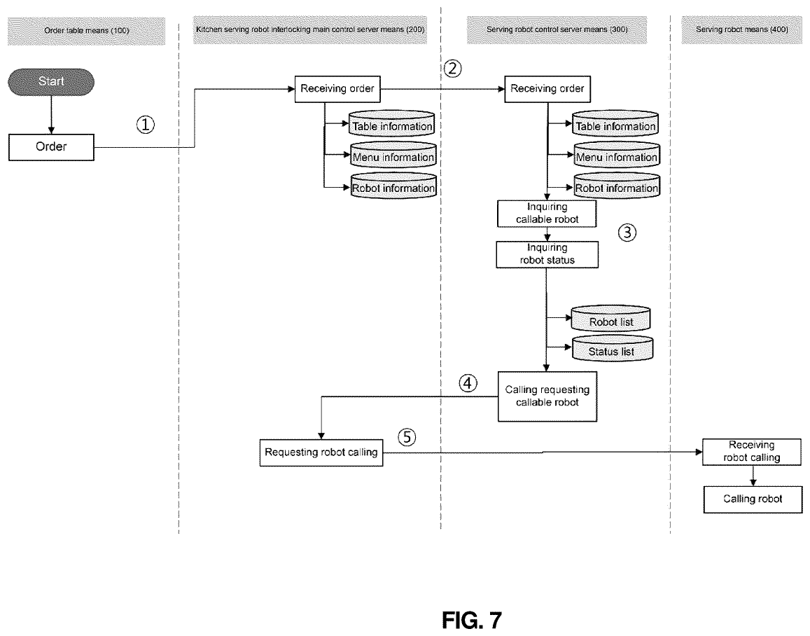

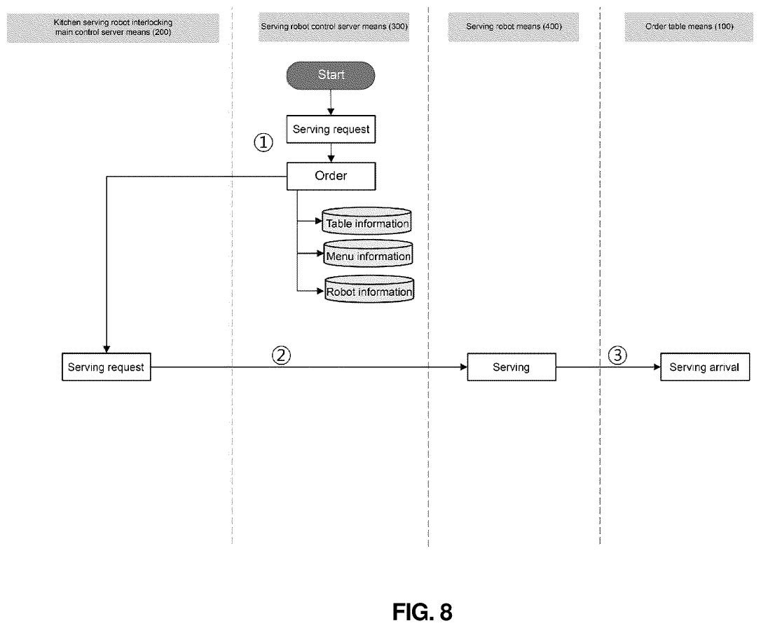

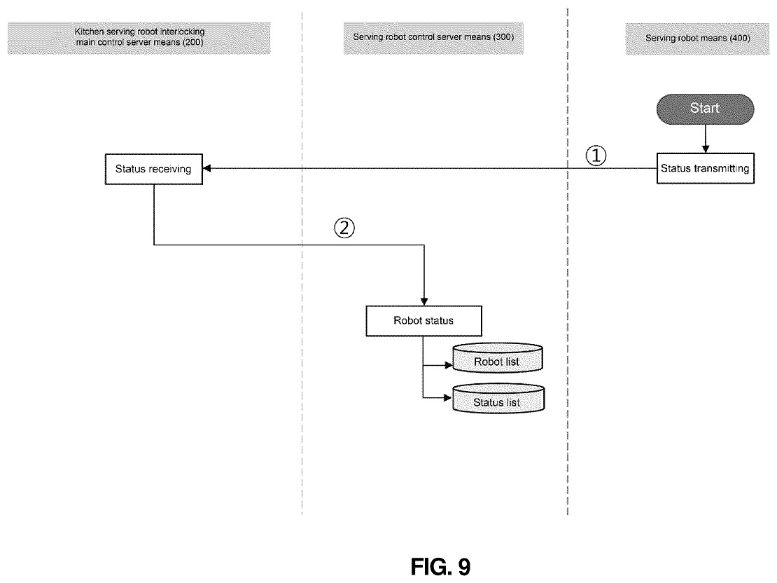

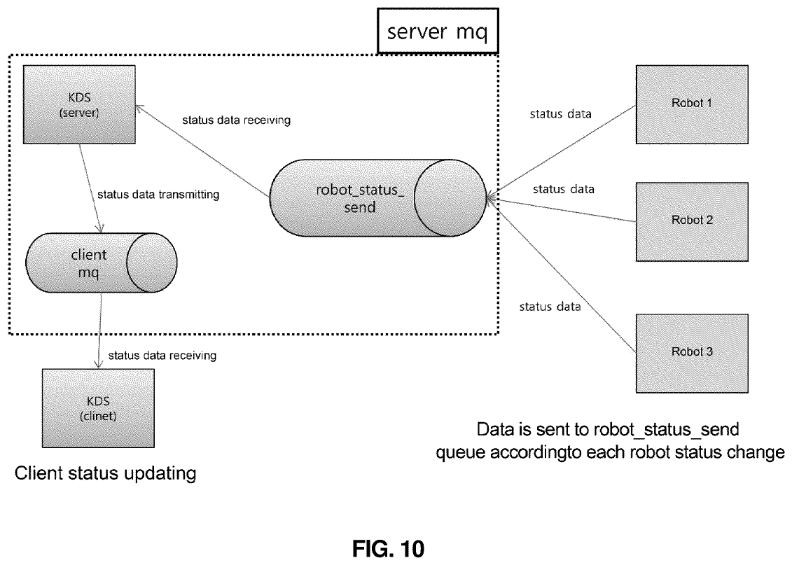

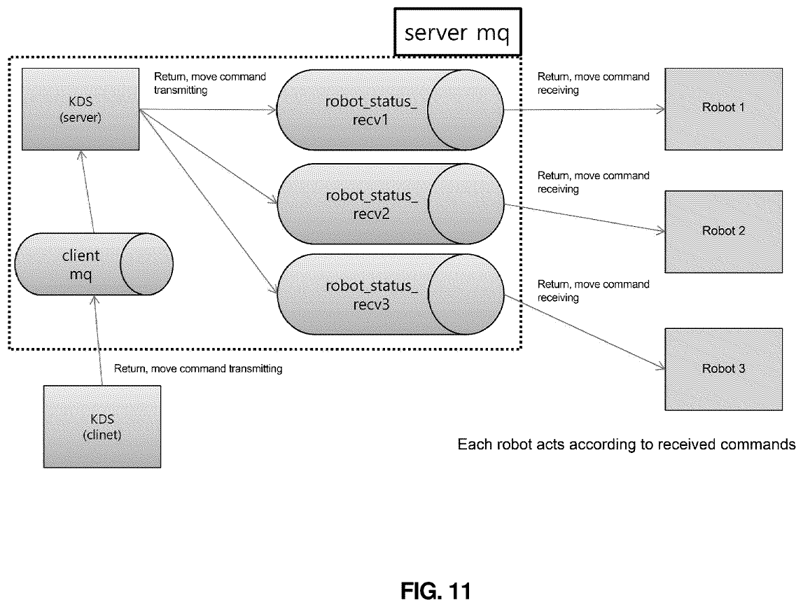

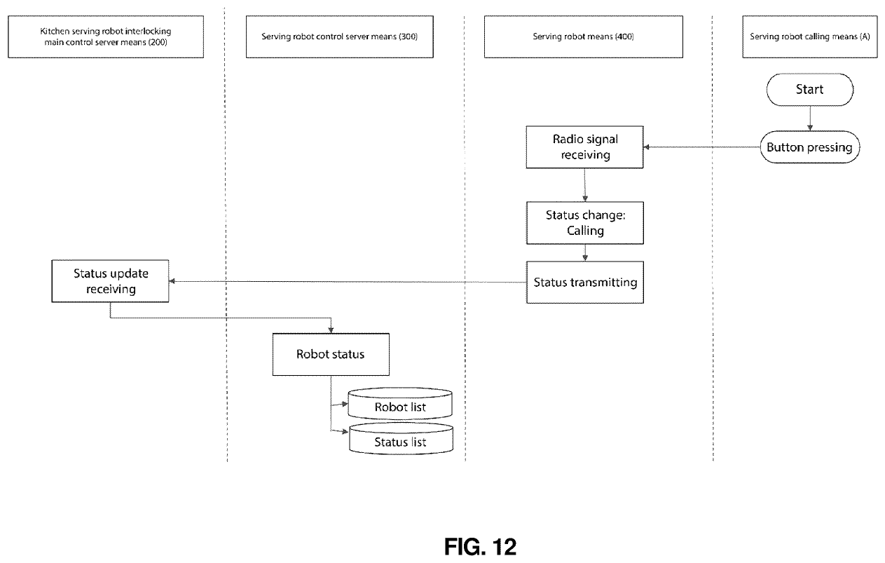

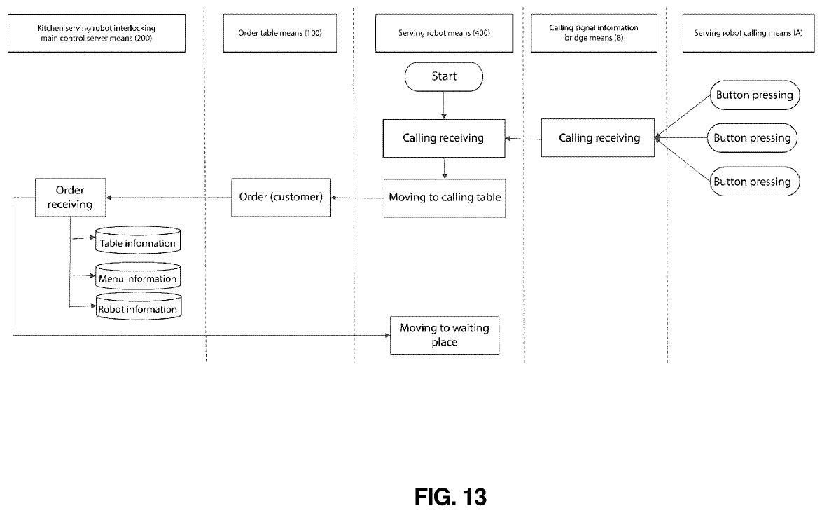

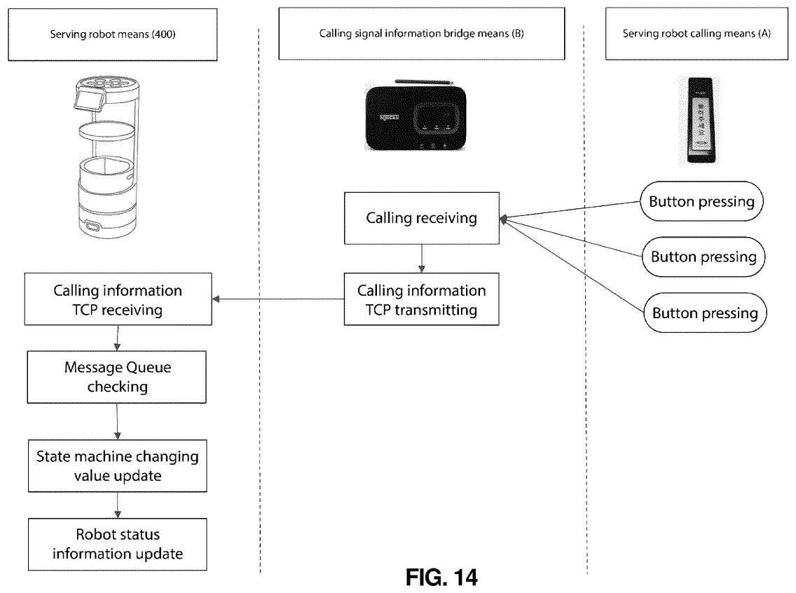

FIG. 1 illustrates a conceptual diagram of a service robot interlocking kitchen control system capable of processing a calling bell signal according to the present invention; FIG. 2 illustrates a schematic block diagram of a service robot interlocking kitchen control system capable of processing a calling bell signal according to the present invention; FIG. 3 illustrates an example view of a list requesting message of a serving robot means of a service robot interlocking kitchen control system capable of processing a calling bell signal according to the present invention; FIG. 4 illustrates an example view of a calling message of a serving robot means of a service robot interlocking kitchen control system capable of processing a calling bell signal according to the present invention; FIG. 5 illustrates an example view of a serving requesting message of a serving robot means of a service robot interlocking kitchen control system capable of processing a calling bell signal according to the present invention; FIG. 6 illustrates an example view of a serving and calling completion message of a serving robot means of a service robot interlocking kitchen control system capable of processing a calling bell signal according to the present invention; FIG. 7 illustrates a schematic block diagram of a process for receiving order information and calling a serving robot means of a serving robot interlocking kitchen control system capable of processing a calling bell signal according to the present invention; FIG. 8 illustrates a schematic block diagram of a process for serving of a serving robot means of a serving robot interlocking kitchen control system capable of processing a calling bell signal according to the present invention; FIG. 9 illustrates a schematic block diagram of a process for transmitting real-time state information of a serving robot means of a serving robot interlocking kitchen control system capable of processing a calling bell signal according to the present invention; FIG. 10 illustrates a conceptual diagram of a process for transmitting real-time state information of a serving robot means of a serving robot interlocking kitchen control system capable of processing a calling bell signal according to the present invention; FIG. 11 illustrates a conceptual diagram of a process for a calling transmitted to a serving robot means of a serving robot interlocking kitchen control system capable of processing a calling bell signal according to the present invention; FIG. 12 illustrates a schematic first block diagram of a process for processing a calling bell signal of a serving robot interlocking kitchen control system capable of processing a calling bell signal according to the present invention; FIG. 13 illustrates a schematic second block diagram of a process for processing a calling bell signal of a serving robot interlocking kitchen control system capable of processing a calling bell signal according to the present invention; and FIG. 14 illustrates a schematic third block diagram of a process for processing a calling bell signal of a serving robot interlocking kitchen control system capable of processing a calling bell signal according to the present invention.

As shown in FIG. 1 to FIG. 14, a service robot interlocking kitchen control system (1) capable of processing a calling bell signal according to the present invention includes:
an order table means (100) where a customer can sit down and that requests an order;
a serving robot calling means (A) located and formed on one side of the order table means (100) and capable of calling a serving robot means (400) with the order table means (100), where the customer is located, through a physically manipulation of the customer;
a calling signal information bridge means (B) that receives calling signal information including information of the order table means (100) through the serving robot calling means (A) and transmits the received calling signal information to the serving robot means (400);
a kitchen serving robot interlocking main control server means (200) that receives, stores, and manages information of the order table means (100) called in real time through the serving robot calling means (A), order information and requesting item input by the customer in real time using the serving robot means (400), information of the serving robot means (400), and a real-time state information transmitted in real time from the serving robot means (400), receives callable information about the serving robot means (400) transmitted through a serving robot control server means (300), and allows the serving robot means (400) to be called into the kitchen, based on the callable information;
the serving robot control server means (300) that receives order information and requesting item and information on the serving robot means (400) in position from the kitchen serving robot interlocking main control server means (200), and materializes information to call the serving robot means (400) through the kitchen serving robot interlocking main control server means (200), based on the received order information and requesting item, and the information of the serving robot means (400) in possession;
the serving robot means (400) that provides various services by driving the kitchen and the hall (inside the store) through the call of the kitchen serving robot interlocking main control server means (200) and the call by the serving robot calling means (A), based on the information transmitted from the serving robot control server means (300) to the kitchen serving robot interlocking main control server means (200) and the calling signal information transmitted from the calling signal information bridge means (B);
a hall-serving robot information output means (500) that is positioned and installed in the kitchen, outputs the order information and requesting item of the customer input from the order table means (100) and the serving robot means (400), the information of the order table means (100) called through the serving robot calling means (A), and the information processed by the serving robot control server means (300), and allows the serving robot means (400) to be called into the kitchen, through the kitchen serving robot interlocking main control server means (200); and
a kitchen control system control means (600) that manages information transfer between the order table means (100), the kitchen serving robot interlocking main control server means (200), the serving robot control server means (300), the serving robot means (400), the hall-serving robot information output means (500), the serving robot calling means (A), and the calling signal information bridge means (B).

Therefore, in the kitchen, the order information and requesting item input through the order table means (100) and the serving robot means (400) and the real-time information of the serving robot means (400) are checked, and the serving robot means (400) is called, thereby managing and controlling the serving robot means (400) in the kitchen so as to provide optimal service by the serving robot means (400).

In addition, the serving robot means (400) can be called and the customer can easily receive various services through the serving robot means (400) with the use of the serving robot calling means (A) by the customer in the order table means (100).

That is, in the kitchen, the order information and various requesting items input from the order table means (100) or the serving robot means (400) located in the hall and the real-time state of the serving robot means (400) can be confirmed through the hall-serving robot information output means (500) and, based on the information (the order information, the requesting item, the real-time state information of the serving robot means (400)) specified through the serving robot control server means (300), the serving robot means (400) is managed and controlled to provide the service to the customers.

In addition, the calling signal information generated from the serving robot calling means (A) is transferred to the serving robot means (400) through the calling signal information bridge means (B) so that the serving robot means (400) can process the calling signal information, thereby providing the kitchen control system (1) linked to the serving robot capable of processing the calling bell signal that maximizes the ease of using the service of the hall (inside the store) for the kitchen and the customers.

The present invention will be described in more detail.

The order table means (100), as a first embodiment, includes:
a customer order information input unit (110) that allows the customers to input the order information and requesting item; and
a service physical receiving unit (120) that allows the customers to receive service for the order information and requesting item input by using the customer order information input unit (110) through the serving robot means (400).

Therefore, it allows the customers to freely input the order information and requesting item and receive corresponding services through the serving robot means (400).

At this time, in the order information input through the customer order information input unit (110), an order time, an order menu (menu, number, etc.), an unique number of the service physical receiving unit (120), sales information, sales information (sale date), an order number, store information, POS information, delivery information (address, delivery app information, etc.), and order type information (hall order, delivery order), etc. are included.

In addition, the requesting item can include various additional requirements requested by the customers, for example, additional requests for water, drinks, and food, etc.

The order table means, as a second embodiment, includes a service physical receiving unit (120) that allows the customers to receive service for the order information and requesting item input by using the customer order information input unit (110) through the serving robot means (400).

Accordingly, it allows the customers to receive the corresponding service through the serving robot means (400).

At this time, the customers can call the serving robot means (400) by using the serving robot calling means (A) and input the order information and requesting item through the serving robot means (400) that has arrived at the service physical receiving unit (120).

The serving robot calling means (A), for example as a calling bell-shaped calling means for the customer to call the serving robot means (400) to the order table means (100) where the corresponding customer is located, includes:
a service request serving robot calling button unit (A1) for calling the serving robot means (400) to input the order information and requesting item;
a menu designation serving robot calling button unit (A2) for calling the serving robot means (400) to immediately receive a set specific requesting item; and
a serving robot calling cancellation button unit (A3) for canceling the calling signal of the serving robot means (400) by invalidating signals called from the service request serving robot calling button unit (A1) and the menu designation serving robot calling button unit (A2).

Accordingly, the customers call the serving robot means (400) in the hall (inside the store), so that they can receive various services.

At this time, when the serving robot means (400) is moved by the calling signal of the service request serving robot calling button unit (A1) or the menu designation serving robot calling button unit (A2), if the signal of the serving robot calling cancellation button unit (A3) is received, the movement thereof is stopped and the previous state is restored.

The calling signal information bridge means (B) includes:
a serving robot calling signal receiving unit (B1) for receiving a real-time call signal generated from the serving robot calling means (A); and
a serving robot calling signal transmission unit (B2) that informationizes the call signal received from the serving robot calling signal receiving unit (B1) and transmits the calling signal information to the serving robot means (400).

Accordingly, the real-time calling signal information generated from the serving robot calling means (A) is transferred to the serving robot means (400), and the serving robot means (400) moves to the location where the calling bell signal is generated based on the calling signal information, so that it can provide various services to the customers.

The kitchen serving robot interlocking main control server means (200) includes:
a main control customer order information receiving unit (210) for receiving the information on the order information and requesting item input through the customer order information input unit (110) or the serving robot means (400);
a main control customer order information storage unit (220) for storing the order information and requesting item received through the main control customer order information receiving unit (210); and
a main control serving robot calling function unit (230) for calling the serving robot means (400) and providing the services so as to solve the order information and requesting item stored in the main control customer order information storage unit (220);
a main control serving robot information management unit (240) that stores and manages the information of the serving robot means (400) (number, ID, unique number of serving robot means) in possession; and

A serving robot real-time state information transmission unit (250) that receives the real-time state of the serving robot means (400) transmitted from the serving robot means (400) and transmits it to the serving robot control server means (300).

In addition, the main control customer order information receiving unit (210) includes:
a first table information receiving module (211) for receiving information about a unique number of the service physical receiving unit (120) according to the location of the service physical receiving unit (120); and
a first service information receiving module (212) for receiving the order information and requesting item input through the customer order information input unit (110) or the serving robot means (400).

Accordingly, the order item and requesting item input by the customer from the order table means (100) or the serving robot means (400) are received and stored therein and then, are transmitted to the serving robot control server means (300), so that the serving robot control server means (300) materializes the information (real-time state) about the serving robot means (400) and transmits them to the kitchen serving robot interlocking main control server means (200), thereby calling the serving robot means (400) in the kitchen through the kitchen serving robot interlocking main control server means (200) and providing the service to the customers.

The serving robot control server means (300) includes:
a main control server transmission information receiving unit (310) that receives information about the order item and requesting item of the order table means (100) transmitted from the kitchen serving robot interlocking main control server means (200);
a main control server transmission information storage unit (320) for storing the order information and requesting item received through the main control server transmission information receiving unit (310);
a second main control serving robot information receiving unit (330) that receives the information of the serving robot means (400) transmitted from the kitchen serving robot interlocking main control server means (200);
a callable serving robot means inquiry unit (340) for inquiring a callable serving robot means (400) capable of processing kitchen and calling bell signals according to the order information and requesting item stored in the main control server transmission information storage unit (320), based on the information about the serving robot means (400) received through the second main control serving robot information receiving unit (330);
a serving robot means state inquiry unit (350) that inquires a real-time state of the callable serving robot means (400) inquired through the callable serving robot means inquiry unit (340); and
a serving robot means calling requesting unit (360) for requesting a call command of the callable serving robot means (400) inquired from the serving robot means state inquiry unit (350) to the kitchen serving robot interlocking main control server means (200).

The main control server transmission information receiving unit (310) includes:
a second table information receiving module (311) for receiving information about a unique number of the service physical receiving unit (120) according to the location of the service physical receiving unit (120) transmitted from the kitchen serving robot interlocking main control server means (200); and
a second service information receiving module (312) for receiving the order information and requesting item transmitted from the kitchen serving robot interlocking main control server means (200).

Accordingly, the order item and requesting item transmitted from the kitchen serving robot interlocking main control server means (200) are received and stored, and the serving robot means (400) can be called in the kitchen through the kitchen serving robot interlocking main control server means (200) according to the received and stored information.

In addition, the serving robot means state inquiry unit (350) includes:
a callable serving robot means list module (351) that lists information on the callable serving robot means (400) inquired through the callable serving robot means inquiry unit (340); and
a callable serving robot means state information acquisition module (352) that can obtain information on the real-time state of the callable serving robot means (400), based on the list of the callable serving robot means (400) obtained from the callable serving robot means list module (351).

Accordingly, the information of the serving robot means (400) that can be called is transferred to the kitchen serving robot interlocking main control server means (200), so that the serving robot means (400) waiting to be called in the kitchen can be called.

The serving robot means (400) includes:
a serving robot mechanic body part (410) that drives through the kitchen and the hall (inside the store), based on the calling signal transmitted through the kitchen serving robot interlocking main control server means (200) and the calling signal information bridge means (B) and that is a mechanical medium for connecting the kitchen and the customers; and
a serving robot control unit (420) that controls the serving robot mechanic body (410) to drive through the kitchen and the hall (inside the store), based on the calling signal transmitted through the kitchen serving robot interlocking main control server means (200) and the calling signal information bridge means (B).
in addition, the serving robot control unit (420) includes:
a serving robot calling signal receiving module (421) for receiving the calling signal transmitted from the kitchen serving robot interlocking main control server means (200);
a calling signal information receiving module (422) for receiving the calling signal information by the customers transmitted from the calling signal information bridge means (B);
a serving robot calling and driving module (423) for driving to the kitchen, which is a calling place, and a corresponding order table means (100) located in the hall (inside the store) according to the calling signal received by the serving robot calling signal receiving module (421) and the calling signal information receiving module (422);
a serving robot service providing module (424) for completing the requesting item requested from the kitchen serving robot interlocking main control server means (200) and the customers by driving to the kitchen and the order table means (100) located in the hall (inside the store) by means of the serving robot calling and driving module (423); and
a serving robot real-time state transmission module (425) that transmits its real-time state to the kitchen serving robot interlocking main control server means (200).

Accordingly, the real-time state of the serving robot mechanic body part (410) is transmitted to the kitchen serving robot interlocking main control server means (200) and, based on this, the calling signal transmitted from the kitchen serving robot interlocking main control server means (200) and various requesting items can be completed.

In addition, the customer's calling signal using the serving robot calling means (A) is received through the calling signal information bridge means (B), so that it is moved to the order table means (100) where the calling signal is generated, thereby carrying out the customer's requesting item.

At this time, the calling signal information receiving module (422) includes:
a calling bell calling signal receiving element (422-1) for receiving the calling signal information of the real-time calling bell transmitted from the calling signal information bridge means (B):
a calling information message queue confirmation element (422-2) for confirming the calling signal information received through the calling bell calling signal receiving element (422-1);
a serving robot state machine change value update element (422-3) that changes and updates the current state information of the serving robot mechanic body part (410), based on the calling signal information confirmed through the calling information message queue confirmation element (422-2); and
a serving robot state information update element (422-4) that transmits the current state information about the serving robot mechanic body part (410) to the kitchen serving robot interlocking main control server means (200) by updating the current state information of the serving robot mechanic body part (410) changed and updated through the serving robot state machine change value update element {422-3}.

Accordingly, based on the calling signal information transmitted from the calling signal information bridge means (B), it is possible to easily provide various services to the customers. At the same time, the current state information is updated and then, the updated current state information is transmitted to the kitchen serving robot interlocking main control server means (200), so that the kitchen serving robot interlocking main control server means (200) can recognize the current state information of the serving robot means (400) updated in real time.

In addition, the serving robot calling and driving module (423) includes:
a general calling driving element (423-1) that allows the serving robot to travel to the kitchen in response to an artificial calling signal in the kitchen transmitted from the kitchen serving robot interlocking main control server means (200); and
a calling bell calling driving element (423-2) that allows the serving robot to travel to the order table means (100) in response to a calling signal transmitted from the calling signal information bridge means (B).

Accordingly, it is possible to recognize whether the serving robot means (400) is moved according to the artificial calling signal in the kitchen or the calling signal by the serving robot calling means (A).

In addition to this, it further includes a serving robot colleague consciousness generating unit (430) that optimally processes the calling signal information transmitted from the calling signal information bridge means (B) in a state where the plurality of serving robot means (400) located and driven in the kitchen and the hall (inside the store) share their mutual location and current state, so that the serving robot means (400) moves to the corresponding order table means (100) and provides various services to the customers.

The plurality of serving robot means (400) located and driven in the kitchen and the hall (inside the store) can recognize the mutual positional relationship and the current state, so that the customers can be served in an optimal way.

That is, when the calling signal information is transmitted to the serving robot means (400) through the calling signal information bridge means (B), since the serving robot means (400) can process the calling signal information in an optimal way by recognizing the mutual positional relationship and the current state thereof, it can optimally move to the position of the order table means (100) where the calling signals are generated.

The optimal way means that the serving robot means (400) moves to the order table means (100) along the optimal path or is arranged in the position closest to the order table means (100) where the calling signal is generated, so that it moves to the customer in the fastest time to provides the corresponding service.

At this time, a more specific example is as follows.

In consideration of various cases, such as a state of the serving robot means (400) moving to the kitchen with the kitchen calling signal, a state of the serving robot means (400) moving to the customer with the kitchen calling signal, a state of the serving robot means (400) of providing service, a state of the serving robot means (400) moving to a specific location after providing the corresponding service, and a state of the serving robot means (400) waiting at a specific location etc., the serving robot means (400) that can arrive at the customer who generated the calling signal within the fastest time can move to the corresponding order table means (100).

The hall-serving robot information output means (500), which is located and installed in the kitchen, checks the order information and requesting item input from the order table means (100) or the serving robot means (400) through the kitchen serving robot interlocking main control server means (200) and the real-time state information of the serving robot means (400) in the kitchen, and outputs various information received from the kitchen serving robot interlocking main control server means (200) in order to call the serving robot means (400) in a state capable of providing the services to the hall and deliver the services to the customers, so that various needs of the customers and the real-time status of the serving robot means (400) can be checked.

The kitchen control system control means (600), as mentioned above, serves to ensure smooth information transfer between the order table means (100), the kitchen serving robot interlocking main control server means (200), the serving robot control server means (300), the serving robot means (400), the hall-serving robot information output means (500), the serving robot calling means (A), and the calling signal information bridge means (B). At the same time, the functions and roles of the order table means (100), the kitchen serving robot interlocking main control server means (200), the serving robot control server means (300), the serving robot means (400), the hall-serving robot information output means (500), the serving robot calling means (A), and the calling signal information bridge means (B) are performed according to various situations.

A brief summary of the roles of each component of the service robot interlocking kitchen control system (1) capable of processing a calling bell signal according to the present invention is as follows.

In the order table means (100), the order information and requesting item are generated by customers for the first time.

The serving robot calling means (A) allows the customer to call the serving robot means (400).

In the calling signal information bridge means (B), when the customer calls the serving robot means (400), the calling signal is received and transmitted to the serving robot means (400).

The kitchen serving robot interlocking main control server means (200) receives and stores the order information and requesting item from the order table means (100) or the serving robot means (400);
delivers them to the serving robot control server means (300);
receives and stores the real-time state from the serving robot means (400);
stores and manages the information (number, ID, unique number, etc.) of the serving robot means (400);
delivers the information (number, ID, unique number, etc.) and real-time state information of the serving robot means (400) to the serving robot control server means (300); and
allows the calling command to transmit to the serving robot means (400), based on the information transmitted from the serving robot control server means (300).

The serving robot control server means (300) receives and stores the order information, the requesting item, the information of the serving robot means (400), and the real-time state information transmitted from the kitchen serving robot interlocking main control server means (200);
inquires the serving robot means (400) that can be called, based on the above information received and stored;
inquires the list and real-time state information of the queried serving robot means (400); and
transmits the information on the callable serving robot means (400) to the kitchen serving robot interlocking main control server means (200), so that the kitchen serving robot interlocking main control server means (200) enables the serving robot means (400) to be called.

The serving robot means (400) receives the calling signal information transmitted from the kitchen serving robot interlocking main control server means (200) and the calling signal information bridge means (B);
provides the services to the customers in response to the calling signal information generated by the customers;
transmits the real-time state information to the kitchen serving robot interlocking main control server means (200); and
sets the route to the destination and allows the serving robot means to drive along the set route in response to the call command transmitted from the kitchen serving robot interlocking main control server means (200).

The hall-serving robot information output means (500), which is located and installed in the kitchen can check the order information, the requesting item, the information of the serving robot means (400), and real-time state information in the kitchen; and
transmits the calling command to the serving robot means (400).

At this time, the calling command includes the destination information (position of the service physical receiving unit (120)) that allows the serving robot means (400) to complete the task to be solved, and the information about the type of service (serving) to be completed.

In the kitchen control system control means (600), each of the above components forms an organic coupling relationship, so that the call command and the services are smoothly progressed and provided therein.

On the other hand, based on the service robot interlocking kitchen control system (1) capable of processing a calling bell signal according to the present invention, the organic coupling relationship of each component in various situations will be described.

Referring to FIG. 7, first, in the case of order information reception and calling process (case 1), when the order information and the requesting item are input through the order table means (100), the information is transmitted to the kitchen serving robot interlocking main control server means (200).

The kitchen serving robot interlocking main control server means (200) transmits the received information, the previously stored and managed information (information of the serving robot means (400)) to the serving robot control server means (300).

The serving robot control server means (300) searches for the serving robot means (400) that can be called, based on the information received from the kitchen serving robot interlocking main control server means (200).

The serving robot control server means (300) obtains the real-time state information of the inquired serving robot means (400), and requests to call the callable serving robot means (400) to the kitchen serving robot interlocking main control server means (200).

The kitchen serving robot interlocking main control server means (200) calls the serving robot means (400), so that the serving robot means (400) can complete the mission according to the calling command.

Referring to FIG. 8, in the case of the service provision process (case 2), the information and real-time state of the serving robot means (400) that can be called by the serving robot control server means (300) are arranged, and the calling is requested to the kitchen serving robot interlocking main control server means (200).

The kitchen serving robot interlocking main control server means (200) calls the serving robot means (400).

The serving robot means (400) moves to the corresponding service physical receiving unit (120) according to the calling command transmitted from the kitchen serving robot interlocking main control server means (200) to provide the service.

Referring to FIG. 9, in the case of the real-time state checking process of the serving robot means (400) (case 3), the serving robot means (400) transmits its real-time state information to the kitchen serving robot interlocking main control server means (200).

When the real-time state information of the serving robot means (400) is transmitted to the kitchen serving robot interlocking main control server means (200), the kitchen serving robot interlocking main control server means (200) transmits the real-time state information received from the serving robot means (400) to the serving robot control server means (300).

The serving robot control server means (300) enables the real-time state information about the serving robot means (300) to be acquired.

Referring to FIG. 12 through FIG. 14, in the case of the process of the serving robot means (400) of processing the calling bell signal (case 4), when the customer generates the calling signal through the serving robot calling means (A) formed in the order table means (100) where the customer is located, the calling signal information bridge means (B) receives the calling signal and transmits the received calling signal to the serving robot means (400), so that the serving robot means (400) moves to the corresponding order table means (100) where the calling signal is generated, thereby providing various services to the customer.

At this time, the calling signal is received and the real-time state information on the serving robot means (400) whose current state value is changed is transmitted to the kitchen serving robot interlocking main control server means (200), so that the real-time state of the serving robot means (400) is updated.

For reference, ‘information of the order table means (100)’ means the unique position and the unique number of the order table means (100).

As described above, the present invention is not limited to the described embodiment, and it is obvious for those who have common knowledge in the art to variously modify and change the present invention without departing from the idea and the scope of the present invention.

Hence, since the present invention can be realized as various embodiments without departing from the technical idea or the major feature, the embodiments of the present invention are only provided as simple examples and are not to be construed narrowly but can be variously modified.

### Industrial Applicability

The present invention relates a service robot interlocking kitchen control system capable of processing a calling bell signal.

It can be applied to the promotion of the industrial field of the system industry that controls and manages serving robots developed and manufactured for the main purpose of service, especially the industrial field of the serving robot control system industry and the field that uses it, that is, the restaurant industry and so on, in that it checks various information (real-time status) on serving robots in the kitchen and manages and controls the serving robot based on the various information on the serving robot.

1. A service robot interlocking kitchen control system (1) capable of processing a calling bell signal comprising:
an order table means (100) where a customer can sit down and that requests an order;
a serving robot calling means (A) located and formed on one side of the order table means (100) and capable of calling a serving robot means (400) with the order table means (100), where the customer is located, through a physically manipulation of the customer;
a calling signal information bridge means (B) that receives calling signal information including information of the order table means (100) through the serving robot calling means (A) and transmits the received calling signal information to the serving robot means (400);
a kitchen serving robot interlocking main control server means (200) that receives, stores, and manages information of the order table means (100) calling in real time through the serving robot calling means (A), order information and requesting item input by the customer in real time using the serving robot means (400), information of the serving robot means (400), and Real-time state information transmitted in real time from the serving robot means (400), receives callable information about the serving robot means (400) transmitted through a serving robot control server means (300), and allows the serving robot means (400) to be called into the kitchen, based on the callable information;
the serving robot control server means (300) that receives order information and requesting item and information on the serving robot means (400) in position from the kitchen serving robot interlocking main control server means (200), and materializes information to call the serving robot means (400) through the kitchen serving robot interlocking main control server means (200), based on the received order information and requesting item and the information of the serving robot means (400) in possession;
the serving robot means (400) that provides various services by driving the kitchen and hall (inside the store) through the calling of the kitchen serving robot interlocking main control server means (200) and the calling by the serving robot calling means (A), based on the information transmitted from the serving robot control server means (300) to the kitchen serving robot interlocking main control server means (200) and the calling signal information transmitted from the calling signal information bridge means (B);
a hall-serving robot information output means (500) that is positioned and installed in the kitchen, outputs the order information and requesting item of the customer input from the order table means (100) and the serving robot means (400), the information of the order table means (100) called through the serving robot calling means (A), and the information processed by the serving robot control server means (300), and allows the serving robot means (400) to be called into the kitchen, through the kitchen serving robot interlocking main control server means (200); and
a kitchen control system control means (600) that manages information transfer between the order table means (100), the kitchen serving robot interlocking main control server means (200), the serving robot control server means (300), the serving robot means (400), the hall-serving robot information output means (500), the serving robot calling means (A), and the calling signal information bridge means (B),
wherein, in the kitchen, the order information and requesting item input through the order table means (100) and the serving robot means (400) and the real-time information of the serving robot means (400) are checked, and the serving robot means (400) is called, thereby managing and controlling the serving robot means (400) in the kitchen so as to provide optimal service by the serving robot means (400); and
the serving robot means (400) can be called and the customer can easily receive various services through the serving robot means (400) with the use of the serving robot calling means (A) by the customer in the order table means (100).

2. The service robot interlocking kitchen control system according to claim 1,
wherein the serving robot means (400) includes:
a serving robot mechanic body part (410) that drives through the kitchen and the hall (inside the store), based on the calling signal transmitted through the kitchen serving robot interlocking main control server means (200) and the calling signal information bridge means (B) and that is a mechanical medium for connecting the kitchen and the customers; and
a serving robot control unit (420) that controls the serving robot mechanic body (410) to drive through the kitchen and the hall (inside the store), based on the calling signal transmitted through the kitchen serving robot interlocking main control server means (200) and the calling signal information bridge means (B),
wherein the serving robot control unit (420) includes:
a serving robot calling signal receiving module (421) for receiving the calling signal transmitted from the kitchen serving robot interlocking main control server means (200);
a calling signal information receiving module (422) for receiving the calling signal information by the customers transmitted from the calling signal information bridge means (B);
a serving robot calling and driving module (423) for driving to the kitchen, which is a calling place, and a corresponding order table means (100) located in the hall (inside the store) according to the calling signal received by the serving robot calling signal receiving module (421) and the calling signal information receiving module (422);
a serving robot service providing module (424) for completing the requesting item requested from the kitchen serving robot interlocking main control server means (200) and the customer by driving to the kitchen and the order table means (100) located in the hall (inside the store) by means of the serving robot calling and driving module (423); and
a serving robot real-time state transmission module (425) that transmits its real-time state to the kitchen serving robot interlocking main control server means (200),
wherein the real-time state of the serving robot mechanic body part (410) is transmitted to the kitchen serving robot interlocking main control server means (200) and, based on this, the calling signal transmitted from the kitchen serving robot interlocking main control server means 200 and various requesting items can be completed, and
wherein the customer's calling signal using the serving robot call means (A) is received through the calling signal information bridge means (B), so that it is moved to the order table means (100) where the calling signal is generated, thereby carrying out the customer's requesting item.
